(19) United States
(12) Patent Application Publication
(10) Pub. No.: US 2009/0210839 A1
(43) Pub. Date: Aug. 20, 2009

(54) TIMING CLOSURE USING MULTIPLE TIMING RUNS WHICH DISTRIBUTE THE FREQUENCY OF IDENTIFIED FAILS PER TIMING CORNER

(75) Inventors: Nathan C. Buck, Underhill, VT (US); John P. Dubuque, Jericho, VT (US); Eric A. Foreman, Fairfax, VT (US); Peter A. Habitz, Hinesburg, VT (US); Kerim Kalafala, Rhinebeck, NY (US); Gregory M. Schaeffer, Poughkeepsie, NY (US); Chandramouli Visweswariah, Croton-on-Hudson, NY (US)

Correspondence Address: FREDERICK W. GIBB, III;Gibb Intellectual Property Law Firm, LLC, 2568-A RIVA ROAD, SUITE 304, ANNAPOLIS, MD, 21401, US

(73) Assignee: INTERNATIONAL BUSINESS MACHINES CORPORATION, Armonk, NY (US)

(21) Appl. No.: 12/031,106

(22) Filed: Feb. 14, 2008

(51) Int. Cl. G06F 17/50

(52) U.S. Cl. 716/6

(57) ABSTRACT

A method of timing closure for integrated circuit designs uses multiple timing runs which distribute the frequency of identified fails per timing corner (between starting timing corners and remaining timing corners) to maximize efficiency in timing analysis. More specifically, the method closes timing for a chosen set of starting timing corners, verifies the remaining timing corners are orthogonal to the starting timing corners, closes timing for the remaining timing corners using multi-corner analysis, and verifies that all timing corners have positive slack margin.

### BACKGROUND

1. Field of the Invention

The embodiments herein generally relate to integrated circuit design, and more particularly to a method of timing closure for integrated circuit designs that uses multiple timing runs which distribute the frequency of identified fails per timing corner (between starting timing corners) and remaining timing corners to maximize efficiency in timing analysis.

2. Description of Related Art

During the chip design process the complexity of the structures included in the design grows with every design step: from chip planning, synthesis, floor planning placement, clock and test insertion, wiring and final checks. In every design step it is customary to verify the chip performance can be met. One verification step is static timing analysis which attempts to verify that all timing constraints (such as setup and hold times at internal storage elements) are met at a chosen frequency. Traditional industry standard techniques bind the process distributions with a timing run describing the fastest expected chip performance and a second run describing the slowest.

These conditions are not sufficient due to performance inversion and race conditions. In the advanced technologies there is no common setting to define the fastest and slowest performance for all tests on the chip. For example, depending on the transistors used, some paths are faster at high temperature, while most are faster at low temperature. Depending on the amount of metal used, some paths may be dominated by metal resistance, which are faster with thick metal, while most are capacitance dominated which are faster at thin and narrow metal. In addition, all chip tests contain races between two paths, and the determination of which path is faster depends on the path design and the process corner. A process corner is defined as a set of parameters (such as voltage or temperature) and their corresponding settings. Traditional static timing analysis only covers a subset of all possible process corners covering manufacturing and environmental conditions, and therefore there exists the possibility of producing non-functional hardware if the actual manufacturing and/or environmental conditions are different than the limited set of process corners covered by traditional static timing analysis. More recently, multi-corner and statistical timing analysis have been introduced to cover the full set of possible process corners, however, these techniques are known to be time consuming.

### SUMMARY

The present invention teaches a method whereby the vast majority of timing violations are detected, and can be fixed, using a small number of starting corner timing analysis run(s). Once timing is closed in the chosen starting corner(s), additional corners may be successfully added to provide greater process coverage. Alternatively, multicorner and/or statistical techniques may be used to cover the remaining process corners.

Embodiments herein provide a method of timing closure for integrated circuit designs that uses multiple timing runs which distribute the frequency of identified fails per timing corner (between starting timing corners and remaining timing corners) to maximize efficiency in timing analysis. More specifically, the method closes timing for a set of chosen starting timing corners, verifies that the remaining timing corners are orthogonal to the starting timing corners, closes timing for the remaining timing corners using multi-corner analysis, and verifies that all timing corners have positive slack margin.

The design changes to fix the timing failures discovered during the closing of the timing for the starting timing corners may produce timing failures during the closing of the timing for the remaining timing corners, but the reverse is not necessarily true. The closing of the timing for the starting corners fixes more timing errors than the closing of the timing for the remaining timing corners. Each iteration of the closing of the timing for the starting corner(s) is a faster process and requires less computing resources relative to the closing of the timing for the remaining timing corners.

These and other aspects of the embodiments of the invention will be better appreciated and understood when considered in conjunction with the following description and the accompanying drawings. It should be understood, however, that the following descriptions, while indicating embodiments of the invention and numerous specific details thereof, are given by way of illustration and not of limitation. Many changes and modifications may be made within the scope of the embodiments of the invention without departing from the spirit thereof, and the embodiments of the invention include all such modifications.

### BRIEF DESCRIPTION OF THE DRAWINGS

The embodiments of the invention will be better understood from the following detailed description with reference to the drawings, in which:

FIG. 1 is a flow diagram illustrating a method embodiment of the invention; and

FIG. 2 is a flow diagram illustrating a method embodiment of the invention.

### DETAILED DESCRIPTION OF EMBODIMENTS

The embodiments of the invention and the various features and advantageous details thereof are explained more fully with reference to the non-limiting embodiments that are illustrated in the accompanying drawings and detailed in the following description. It should be noted that the features illustrated in the drawings are not necessarily drawn to scale. Descriptions of well-known components and processing techniques are omitted so as to not unnecessarily obscure the embodiments of the invention. The examples used herein are intended merely to facilitate an understanding of ways in which the embodiments of the invention may be practiced and to further enable those of skill in the art to practice the embodiments of the invention. Accordingly, the examples should not be construed as limiting the scope of the embodiments of the invention.

As mentioned above, traditional timing tests do not cover the entire timing process space. To account for the remaining process space, multi-corner timing analysis is needed, which consumes a large amount of computer resources and design time. Additionally, all timing fails need to be fixed and the success of the fix is verified with additional timing runs. The invention enables these final timing tests to be analyzed and fixed.

The final timing closure process iterates repeatedly between a timing run pointing out a design problem, and a change in the netlist to fix it. In order to make this process more efficient, it is important that the timing runs are fast. Therefore, the invention breaks the possible design problems into categories according to the number of design problems each exposes and the runtime this exposure costs. This methodology reduces the overall timing closure effort significantly.

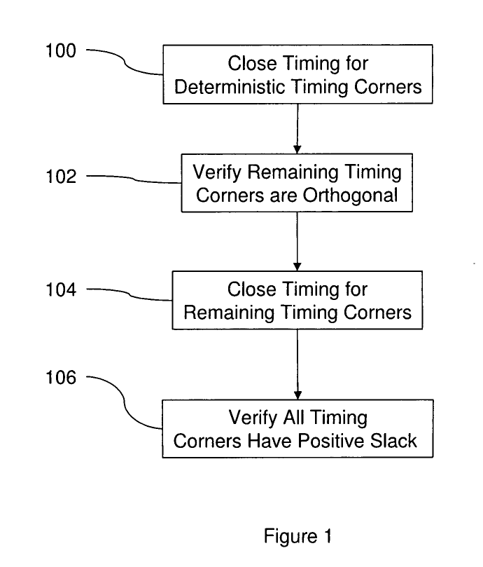

More specifically, as shown in flowchart form in FIG. 1, embodiments herein provide a method of timing closure for integrated circuit designs that uses multiple timing runs which distribute the frequency of identified fails per timing corner between starting timing corners and remaining timing corners to maximize efficiency in timing analysis. More specifically, the method closes timing for the starting timing corners in item 100. This process 100 performs iterations of timing runs describing the fastest expected chip performance and iterations of second runs describing the slowest expected chip performance. After closing timing for the starting timing corners in item 100, in item 102, the method verifies that the remaining timing corners are orthogonal to the starting timing corners.

In item 104, the method closes timing for the remaining timing corners using multi-corner analysis. The timing failures discovered during the closing of the timing for the starting timing corners 100 may produce timing failures during the closing of the timing for the remaining timing corners 104, but the reverse is not necessarily true. The closing of the timing for the starting corners 100 fixes more timing errors (e.g., up to 90% of all errors) than the closing of the timing for the remaining timing corners 104. However, each iteration of the closing of the timing for the starting corners 100 is a faster process and requires less computing resources relative to the closing of the timing for the remaining timing corners 104, which makes the process very efficient. In item 106, the method verifies that all timing corners have positive slack margin.

Thus, the invention enables the removal of most of the design problems quickly by using only the standard fast and slow chip analysis, and then tackles the problems caused by performance inversion and race sensitivity in a second set of timing runs. The additional runs are more complex, but expose a much smaller number of problems and require a smaller number of fix up iterations. Despite of the fact that the performance inversion and race condition problems are not exposed in the first set of iterations, the overall timing closure effort is significantly reduced.

In addition, the traditional fast and slow runs are not more pessimistic than the additional runs which look at the additional process corners. The starting corner runs do not add additional timing margin (for example, adding +100 psec for test to guard against optimistic timing results). Additionally, the fast and slow runs may take advantage of many slack credits which were developed over time to eliminate pessimism. Therefore, the initial fast and slow chip runs should be considered intelligent fast and slow chip runs. As a result of this, the fast/slow intelligent runs are quick and efficient while not fixing timing violations unnecessarily. Since the initial runs are not fixing violations unnecessarily, the intelligent fast/slow runs and multi-corner runs are orthogonal to each other.

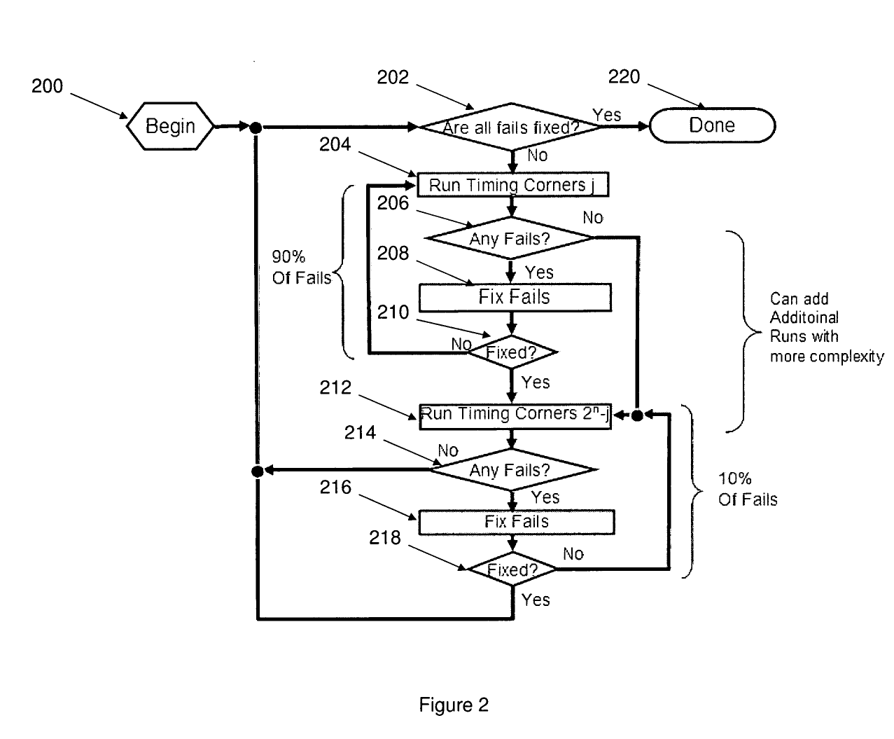

As shown in greater detail in FIG. 2, timing closure is performed by analyzing and closing timing in multiple parts: Timing Corners j and Timing Corners 2ⁿ-j, where j represents the number of starting corner timing runs and n represents the number of process variables within the process space. More specifically, the process begins in item 200. In item 202, the process checks whether all timing failures have been fixed. If so, processing is done (item 220). If not, the process first loops through items 204-210 (which correspond to item 100 in FIG. 1) and then loops through items 212-218 (which correspond to item 104 in FIG. 1).

More specifically, in item 204, the method performs a timing analysis on starting timing corners (identified as “j” herein). The processing in item 204 performs timing runs describing the fastest expected chip performance and second runs describing the slowest expected chip performance. In item 206, if there are not any timing failures, processing proceeds to item 212. If there are timing failures, they are fixed in item 208. If all items are fixed, item 210 similarly directs the processing flow to item 212, if not processing returns to items 204 to iteratively continue the timing analysis on the starting timing corners.

In item 212, the method performs timing analysis on the remaining corners (identified as “2ⁿ-j” herein) that are orthogonal to the starting timing corners. As shown by item 214, if there are timing errors, they are fixed in item 216. If there are no timing errors, item 214 directs processing back to item 202. If all the timing errors are fixed, processing is similarly directed to item 202 by item 218. If not, item 218 directs processing to return to item 212 to run more timing analysis on the remaining corners.

Timing Corners j use intelligent quick timing, whereas timing corners 2ⁿ-j use efficient but more computationally expensive multi-corner timing. Timing corners j, are optimized to identify the majority of timing violations. The repetition of analysis and fix up can be completed primarily in timing corners j. Once completed, statistical or multi-corner timing can be used for timing corners 2ⁿ-j. The number of starting corner timing runs can be at least 1 and up to j possible corners. Additionally, there can be other j corners which contain a subset of sources of variation. Not only would there be j number of smart corners of the 2ⁿ process spaces, but there could be j runs with k number of variables.

In FIG. 2, the outermost loop (items 212-218) has the more limited number of iterations. The majority of iterations, take place with the intelligent fast-chip/slow-chip runs in items 204-210. As mentioned above, failure in the initial level of analysis (items 204-120) is guaranteed to produce a failure in the subsequent multi-corner analysis (items 212-218). By definition, multi-corner analysis covers all process corners, so a failure in one corner is guaranteed to make the worst across all corners negative. The timing analysis becomes more challenging and specialized recipes are required to guarantee the relationship between single and multi-corner analysis.

While some examples discuss limits above, the embodiments herein are not limited to only 2 starting corners. To the contrary, running at nominal may be beneficial as well, and with embodiments herein, N number of starting process corners can be selected from among the 2^{N} subset. Further, after the initial timing analysis (items 204-210) is complete, one could selectively enable a subset of the total set of process variables and fix any new violations before moving on to the final golden analysis (items 212-218) to cover the full set of 2^{N} process corners.

With the introduction of cross-talk coupling induced delay into the multi-corner analysis, it is time-consuming to analyze the effects of coupling on timing in each corner. In order to determine victim and aggressor net switching interactions, timing windows and slew relationships need to be determined. In addition, the effect of coupling induced delay in timing analysis results in a recursive nature. For a dynamic and efficient calculation, a method that could be used with embodiments herein is to leverage an incremental coupling analysis approach and project the base corner coupling information to the other corners. This method avoids an expensive iterative analysis, while not sacrificing accuracy.

Thus, two non-limiting ways of exercising this approach follow. First, freeze aggressor timing windows in a base (starting) corner. Second, in a new corner, incrementally compute Miller factors without iterations (since the aggressors are considered frozen). The Miller factors will reflect the victim's timing at this new corner. Third, on a given stage of logic, the change in Miller coupling factors are known, so one can compute the change in cap. Fourth, (with very little runtime overhead) the sensitivities of delta-delay with respect to a change in cap at the base corner can be computed. Alternatively, the embodiments herein can compute these sensitivities at the new corner by changing the Miller factors and reanalyzing the delay and slew through the victim. All this happens in conjunction with incremental timing calculations.

Another possibility is to perform the foregoing within path tracing. Given each common clock path being analyzed, the embodiments herein can compute the coupling delta-delay at the new corner, and at the same time, compute random nets credit (as outlined in U.S. Pat. No. 7,181,711, to Foreman et al, the complete disclosure of which is incorporated herein by reference). This has the advantage of being able to filter out excess pessimism in the coupling analysis, and also reflect the change in coupling impact at the new corner.

Specifically, in the process, in a similar manner to the incremental coupling approach listed above, the embodiments herein would first compute delta-delays at the new corner based on frozen aggressor information, for each stage in the path being analyzed. Second, using this perturbed timing, the delta-delays are known, so the embodiments herein can compute a random nets credit. Third, the process returns to the common path analysis engine the regularity credit minus the new corner's delta-delay perturbation.

The foregoing description of the specific embodiments will so fully reveal the general nature of the invention that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments of the invention have been described in terms of embodiments, those skilled in the art will recognize that the embodiments of the invention can be practiced with modification within the spirit and scope of the appended claims.

What is claimed is:

1. A method of timing closure by using multiple timing runs which distribute the frequency of identified fails per timing corner between starting timing corners and remaining timing corners to maximize efficiency in timing analysis, said method comprising:
closing timing for said starting timing corners;
verifying said remaining timing corners are orthogonal to said starting timing corners;
closing timing for said remaining timing corners using multi-corner analysis; and
verifying all timing corners have positive slack margin.

2. The method according to claim 1, all the limitations of which are incorporated herein by reference, wherein said closing of said timing for said starting corners fixes more timing errors than said closing of said timing for said remaining timing corners.

3. The method according to claim 1, all the limitations of which are incorporated herein by reference, wherein each iteration of said closing of said timing for said starting corners is a faster process and requires less computing resources relative to said closing of said timing for said remaining timing corners.

4. A method of timing closure by using multiple timing runs which distribute the frequency of identified fails per timing corner between starting timing corners and remaining timing corners to maximize efficiency in timing analysis, said method comprising:
closing timing for said starting timing corners;
verifying said remaining timing corners are orthogonal to said starting timing corners;
closing timing for said remaining timing corners using multi-corner analysis; and
verifying all timing corners have positive slack margin,
wherein timing failures discovered during said closing of said timing for said starting timing corners would produce timing failures during said closing of said timing for said remaining timing corners.

5. The method according to claim 4, all the limitations of which are incorporated herein by reference, wherein said closing of said timing for said starting corners fixes more timing errors than said closing of said timing for said remaining timing corners.

6. The method according to claim 4, all the limitations of which are incorporated herein by reference, wherein each iteration of said closing of said timing for said starting corners is a faster process and requires less computing resources relative to said closing of said timing for said remaining timing corners.
